(19) United States
(12) Patent Application Publication
(10) Pub. No.: US 2002/0116381 A1
(43) Pub. Date: Aug. 22, 2002

(54) Registration of a process with a database manager

(76) Inventor: Chad Grey Thompson, Kuna, ID (US)

Correspondence Address: Fred G. Pruner, Jr., TROP, PRUNER & HU, P.C., Suite 100, 8554 Katy Freeway, Houston, TX, 77024, US

(21) Appl. No.: 09/792,253

(22) Filed: Feb. 22, 2001

(51) Int. Cl. G06F 7/00

(52) U.S. Cl. 707/9

(57) ABSTRACT

A technique includes automatically causing a database manager to remove association of a predetermined program name with previously registered information. After the removal, other information that is associated with the program name is automatically registered with the database manager to associate this other information with the program name.

### BACKGROUND

The invention generally relates to the registration of a process with a database manager.

A database may store a vast amount of information that may need to be sorted for purposes of viewing a selected subset of this information. For example, a particular database may have a variety of information relating to employment information, salaries, benefits, etc. However, it may be desirable to view a particular subset of this information, such as, for example, a subset of information that is displayed by a report that shows vacation time that has been taken by employees.

For purposes of controlling the communication of information to and from the database, a file server may execute a database management program (a database management program made by Oracle®, for example) to establish a database manager. The database manager may serve as a platform to execute a concurrent program for purposes of creating a report of selected information from the database. However, before the concurrent program is used, a concurrent process (that contains the resources for the concurrent program) must be registered with the database manager.

In this manner, one way to register the concurrent process involves entering specific parameters for the concurrent program into electronic forms that are displayed by the database manager. These parameters may include filtering parameters, format control parameters, access privileges and other criteria that control the generation of the report. Executable code is registered with the database manager. The executable code uses these parameters to perform functions that are associated with generation of the report.

As an example, for the above-described vacation time report, the filtering parameters may specify criteria that must be met before a particular employee appears in the report: a required minimum number of vacation days; an employee identification number in a predefined range of numbers; an employment starting date later than a predefined starting date; and an employee starting date earlier than a predefined ending date.

The registration of a concurrent process with the database manager typically is subject to human error and is quite time-consuming. As an example, a typical registration of a concurrent process may consume between the approximately two to five hours. Furthermore, the time required for registration may be compounded by requirements to register the concurrent process in multiple instances, such as instances associated with the development, test and production of the concurrent program.

Thus, there is a continuing need for an arrangement and/or technique to address one or more of the programs that are stated above.

### SUMMARY

In an embodiment of the invention, a technique includes automatically causing a database manager to remove association of a predetermined program name with previously registered information. After the removal, other information that is associated with the program name is automatically registered with the database manager to associate this other information with the program name.

Other features and advantages of the invention will become apparent from the following description drawing and claims.

### BRIEF DESCRIPTION OF THE DRAWING

FIG. 1 is a schematic diagram of a system according to an embodiment of the invention.

FIG. 2 is a flow diagram depicting a general technique to register a concurrent program with a database manager according to an embodiment of the invention.

FIG. 3 is an illustration of a software architecture of the server of FIG. 1 according to an embodiment of the invention.

FIGS. 4 and 5 depict a flow diagram of a more specific technique to register a concurrent program with a database manager according to an embodiment of the invention.

FIG. 6 is a schematic diagram of a computer system according to an embodiment of the invention.

### DETAILED DESCRIPTION

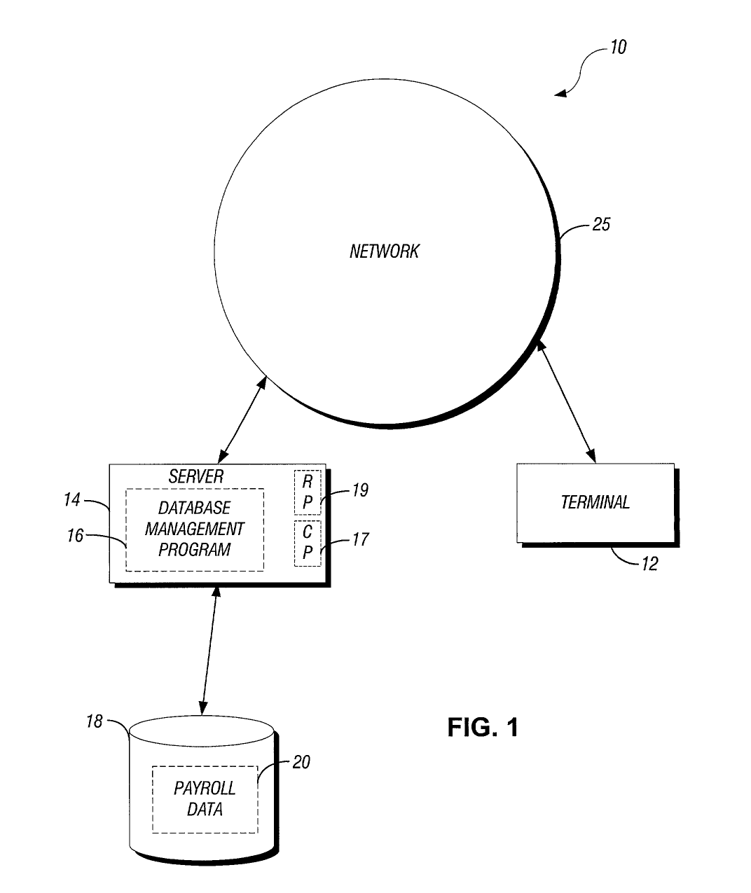

Referring to FIG. 1, an embodiment 10 of a computer system in accordance with the invention includes a server 14 that is coupled to a terminal 12 via a network 25. As an example, the server 14 may control access to a database 18 for purposes of storing data in and retrieving data from the database 18. The database 18 may include a variety of stored information (such as payroll data 20, for example) and may be a relational database, in some embodiments of the invention.

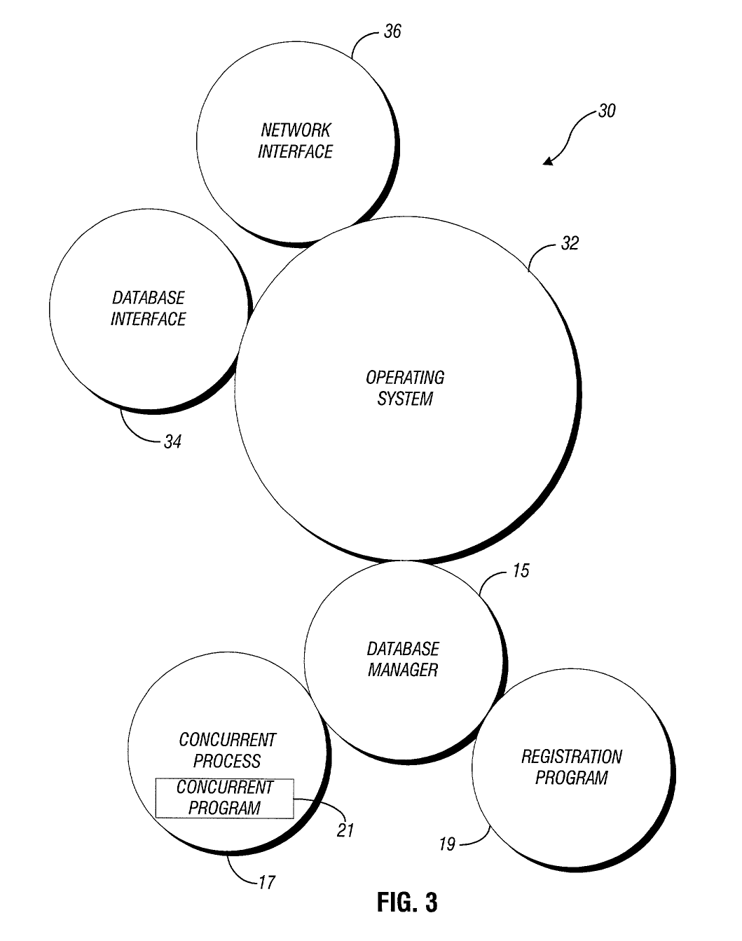

Referring also to FIG. 3, for purposes of managing the communication of data with database 18, the server 14 may execute a database management program 16 (a database management program made by Oracle®, for example) to form a database manager 15. For purposes of customizing the particular information that is retrieved and displayed by the database manager 15, a concurrent process 17 (that contains the resources for the concurrent program 21) may be registered with the database manager 15. To reduce the time needed for registration of the concurrent process 17 and to reduce the number of errors introduced in the registration, the server 14 may execute (via the platform that is provided by the database manager 15) a registration program 19 (a script, for example) to automatically register the concurrent process 17 with the database manager 15, as described below.

The concurrent program 21, when executed by the server 14, causes the server 14 to retrieve selected information from the database 18 to form a customized report, control the formatting of this report and control security access to the report. As an example, the concurrent program 21, when executed by the server 14, may cause the server 14 to create a report that displays employee identification numbers and the number of vacation days that are taken by employees. The concurrent program 21 also specifies the formatting for the report and ensures that the report may only be viewed by users that are associated with a certain security profile, such as human resources personnel, for example.

The concurrent program 21 is established by the database manager 15 during the registration. This executable program is passed the formatting, access rights and filtering parameters obtained via the registration. As described below, not only does the registration program 19 (when executing) cause the server 14 to set up the filtering parameters, format and security access for use by the concurrent program 21, the registration program 19 also de-registers any previously registered instances of the concurrent program 21.

A previous registration may be attributable to the testing and development of the concurrent program 21. In this manner, when the concurrent process 17 is registered, various security groups, filtering parameters and formatting parameters are associated with the name of the concurrent program 21. Thus, before another instance of the concurrent program 21 is registered, the registration program 19 (when executed by the server 14) causes the server 14 to remove the database manager's association of the program's name from previously registered information.

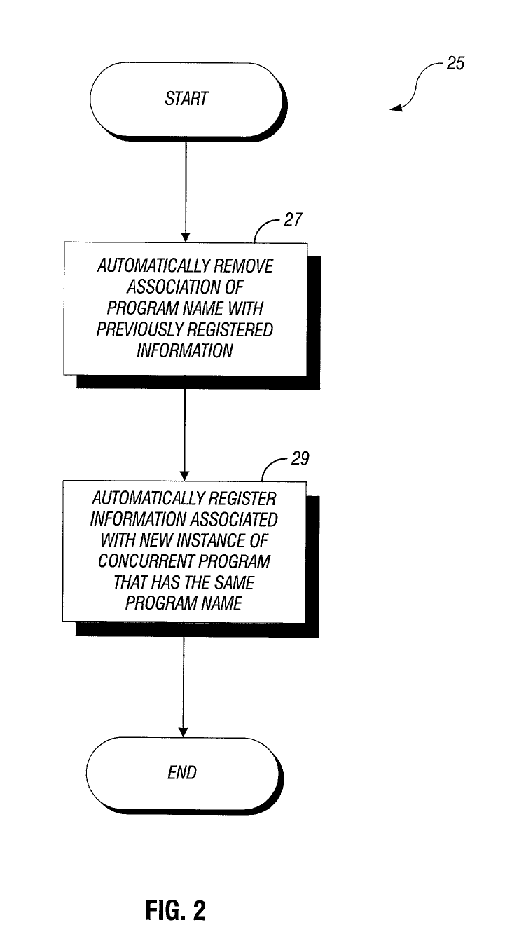

As described below, the server 14 may execute the registration program 19 to automatically register and de-register the concurrent process 17. In this manner, referring to FIG. 2, the registration program 19, when executing, may cause the server 14 to perform a technique 25 to register a concurrent process 17 that is associated with a predetermined concurrent program name. In the technique 25, the server 14 automatically removes (block 27) the association of the program name with previously registered information, as described in more detail below. For example, if another instance of the concurrent program 21 was previously registered, then the database manager 15 associates previously registered information with its program name unless this association is removed. After removing the association between the program name and the previously registered information, the technique 25 includes automatically registering (block 29) information that is associated with the new instance of the concurrent program 21 (that has the same name) with the database manager 15.

FIG. 3 depicts a possible software architecture 30 of the server 14. The concurrent program 21 is executed via a platform that is established by the database manager 15, as the database manager 15 forms an interface between the concurrent process 17 and an operating system 32. Among the other features of the software architecture 30, the architecture 30 may include a network interface 36 for interfacing to the network 25 (see FIG. 1) and a database interface 34 for establishing communication between the server 14 and the database 18.

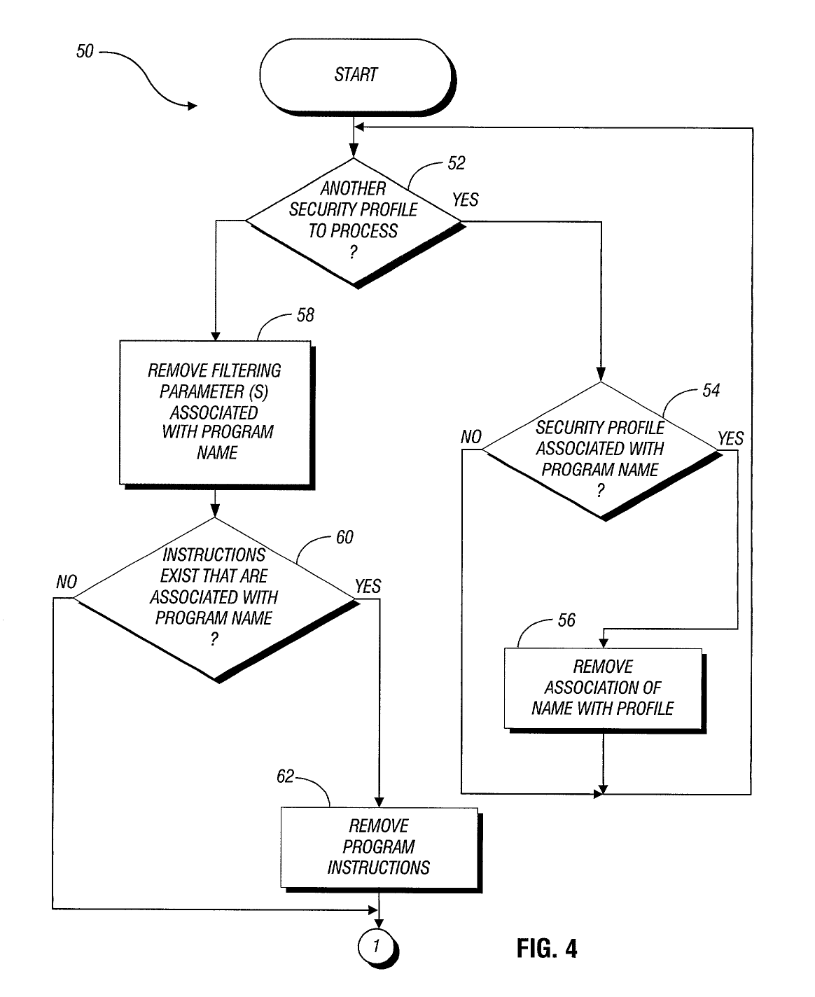

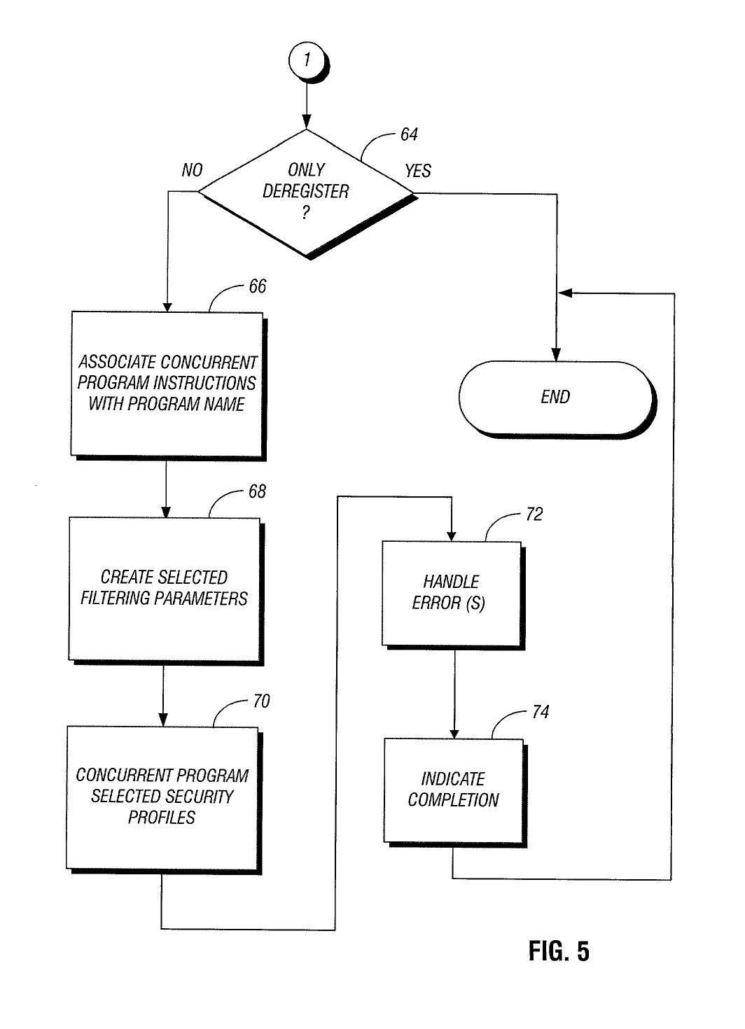

As a more specific example of a possible implementation of the technique 25, in some embodiments of the invention, when executed by the server 14, the registration program 19 may cause the server 14 to perform a technique 50 that is depicted in FIGS. 4 and 5. The technique 50 may initially include causing the server 14 to remove association of the name of the concurrent program 21 with any previously registered information. In this manner, this may include the evaluation of each security profile (also called a “group”) to determine if the program name is associated with the security profile, an association that may be attributable to the registration of a previous instance of the concurrent program 21. As an example, the security profiles may include profiles that distinguish a database administrator, or other functional or security level personnel and generally define who may access, or use, the concurrent program 21.

Thus, in accordance with the technique 50, the execution of the program 19 causes the server 14 to determine (diamond 52) whether another security profile exists to process. If so, the server 14 determines (diamond 54) whether the currently processed security profile is associated with the program name. If so, the server 14 removes (block 56) the association of the program name with the particular security profile. Control returns to diamond 52.

Once the security profiles are processed, the technique 50 includes removing (block 58) filtering parameter(s) that are associated with the same program name, as depicted in block 58. For example, such parameters may include setting a starting date and an ending date for viewing particular information from the database 18. Other filtering parameters are possible, such as parameters that select certain employees, employee numbers, benefits, etc.

The technique 50 next includes determining whether executable code, or instructions, that are associated with an instance of the concurrent program 21 exist, as depicted in diamond 60. If so, then the technique 50 includes removing (block 62) these instructions.

At this point, the de-registration of information associated with any previous instance of the concurrent program 21 or other program having the same name is complete. Therefore, if the user at the terminal 14 has selected (via an option of the registration program 19) only to perform a de-registration, (as indicated by the determination in diamond 64), the technique 50 is terminated. Otherwise, the technique 50 includes associating executable instructions with the program name, as depicted in block 66. Next, the technique 50 includes creating (block 68) filtering parameters that may be set via an option of registration program 19. In this manner, the server 14 may simply reset filtering parameters used by the concurrent program 21 to their default values and set predefined filter parameters to values that are selected by the user. Next, the technique 50 includes associating (block 70) the concurrent program 21 to the selected security profiles. For example, it may be desired that the concurrent program 21 is used by the database administrator and access is otherwise restricted for other security profiles. Lastly, the technique 50 includes handling (block 72) any error(s) and indicating (block 74) completion of the technique 50.

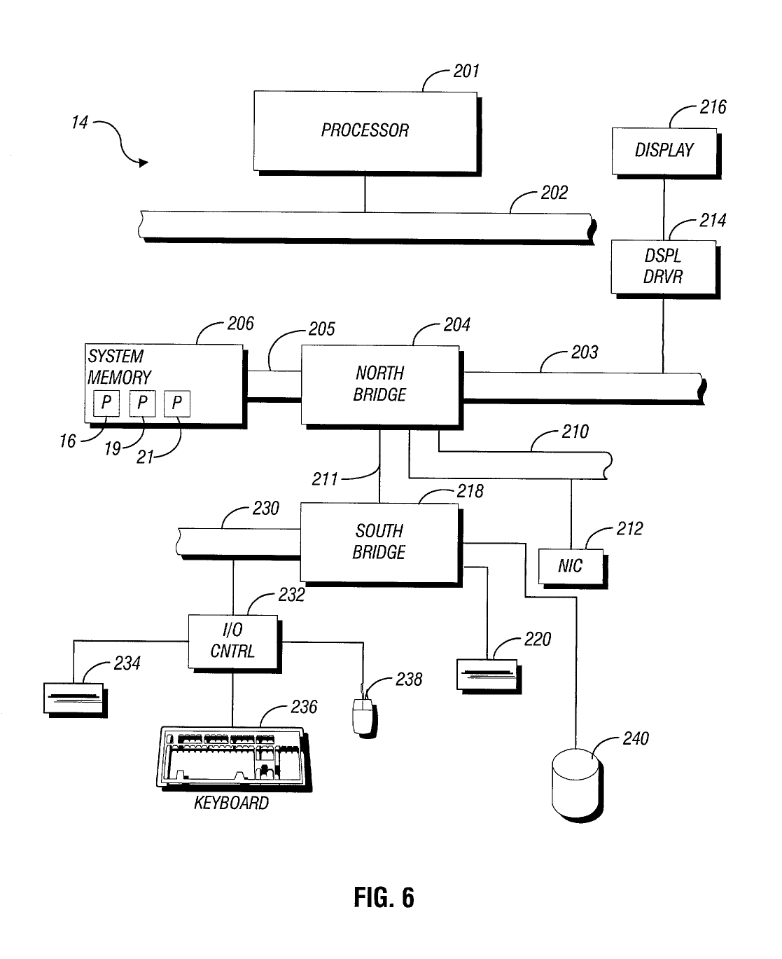

Referring to FIG. 6, in some embodiments of the invention, the server 14 may include a processor 201 that may be coupled to a local bus 202 along with a north bridge 204. The north bridge 204 may represent a collection of semiconductor devices, or “chip set,” and provide interfaces to a Peripheral Component Interconnect (PCI) bus 210 and an AGP bus 203. The PCI Specification is available from The PCI Special Interest Group, Portland, Oreg. 97214. The AGP is described in detail in the Accelerated Graphics Port Interface Specification, Revision 1.0, published on Jul. 31, 1996, by Intel Corporation of Santa Clara, Calif.

A display driver 214 may be coupled to the AGP bus 203 and provide signals to drive a display 216. The PCI bus 210 may be coupled to a network interface card (NIC) 212 that provides a communication interface to the network 25 (see FIG. 1). The north bridge 204 may also include a memory controller to communicate data over a memory bus 205 with a memory 206. As an example, the memory 206 may store all or a portion of program instructions associated with the database management program 16 (see FIG. 1), the concurrent program 21 and registration program 19. In some embodiments of the invention, some of the above-described software may be executed on another computer system that is coupled to the server 14 via a network, such as the network 25.

The north bridge 204 communicates with a south bridge 218 via a hub link 211. The south bridge 218 may represent a collection of semiconductor devices, or “chip set,” and provide interfaces for a hard disk drive 240, a CD-ROM drive 220 and an I/O expansion bus 230, as just a few examples. The hard disk drive 240 may store all or a portion of the instructions of the concurrent program 21, the registration program 19, the database management program 16, and the operating system 32, in some embodiments of the invention.

An I/O controller 232 may be coupled to the I/O expansion bus 230 to receive input data from a mouse 238 and a keyboard 236. The I/O controller 232 may also control operations of a floppy disk drive 234.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
automatically causing a database manager to remove association of a predetermined program name with previously registered information; and
after the removal, automatically registering other information that is associated with the program name with the database manager.

2. The method of claim 1, wherein the automatically causing comprises:
determining if a security profile is associated with the program name; and
based on the determination, disassociating the security profile from the program name.

3. The method of claim 1, wherein the automatically causing comprises:
determining if a filtering parameter is associated with the program name; and
based on the determination, resetting a value associated with the filtering parameter.

4. The method of claim 1, wherein the automatically causing comprises:
removing program instructions associated with the program name.

5. The method of claim 1, wherein the automatically registering comprises:
associating a predetermined filtering parameter with the program name.

6. The method of claim 5, wherein the filtering parameter indicates a date for filtering information from a database.

7. The method of claim 1, wherein the automatically registering comprises:
associating a security profile with the program name.

8. The method of claim 1, wherein the automatically registering comprises:
associating program instructions with the program name.

9. An article comprising a computer readable storage medium storing instructions to cause a computer to:
automatically cause a database manager to remove associating of a predetermined program name with previously registered information; and
after the removal, automatically register other information that is associated with the program name with the database manager.

10. The article of claim 9, wherein the storage medium stores instructions to cause the computer to:
determine if a security profile is associated with the program name, and
based on the determination, disassociate the security profile from the program name.

11. The article of claim 9, wherein the storage medium stores instructions to cause the computer to:
determine if a filtering parameter is associated with the program name; and
based on the determination, reset a value associated with the filtering parameter.

12. The article of claim 9, wherein the storage medium stores instructions to cause the computer to:
remove program instructions associated with the program name.

13. The article of claim 9, wherein the storage medium stores instructions to cause the computer to:
associate a predetermined filtering parameter with the program name.

14. The article of claim 13, wherein the parameter indicates a date for filtering information from a database .

15. The article of claim 9, wherein the storage medium stores instructions to cause the computer to:
associate a security profile with the program name.

16. The article of claim 9, wherein the storage medium stores instructions to cause the computer to:
associate program instructions with the program name.

17. A computer system comprising:
a database associated with a database manager; and
a computer to:
automatically cause the database manager to remove association of a predefined program name with previously registered information, and
after the removal, automatically register other information that is associated with the program name with the database manager.

18. The computer system of claim 17, wherein the computer, during the automatic removal, determines if a security profile is associated with the program name, and based on the determination, disassociates the security profile from the program name.

19. The computer system of claim 17, wherein, during the automatic removal, the computer determines if a filtering parameter of the database management program is associated with the program name and based on the determination, resets a value associated with the parameter.

20. The computer system of claim 17, wherein, during the automatic removal, the computer removes program instructions that are associated with the program name.

21. The computer system of claim 17, wherein during the automatic registration, the computer associates a predetermined filtering parameter with the program name.

22. The computer system of claim 21, wherein the filtering parameter indicates a date for filtering information from the database.

23. The computer system of claim 17, wherein, during the automatic registration, the computer associates a security profile with the program name.

24. The computer system of claim 17, wherein, during the automatic registration, the computer system associates program instructions with the program name.
